(19) United States
(12) Patent Application Publication
(10) Pub. No.: US 2025/0180859 A1
(43) Pub. Date: Jun. 5, 2025

(54) LENS MOUNT, CAMERA MOUNT, OPTICAL APPARATUS, IMAGING APPARATUS, AND IMAGING SYSTEM

(71) Applicant: CANON KABUSHIKI KAISHA, Tokyo (JP)

(72) Inventor: AKIRA YOKOYAMA, Tochigi (JP)

(21) Appl. No.: 18/966,371

(22) Filed: Dec. 3, 2024

(30) Foreign Application Priority Data
Dec. 4, 2023 (JP) 2023-204338

(51) Int. Cl. G02B 7/14

(52) U.S. Cl. CPC G02B 7/14

(57) ABSTRACT

A lens mount attachable to and detachable from a camera mount, the lens mount comprises an outer diameter portion fitted to an inner diameter portion of the camera mount. The outer diameter portion includes a first region and a second region located closer to an object side than the first region. A length in a circumferential direction of a first fitting portion fitted to the inner diameter portion in the second region is longer than a length in the circumferential direction of a second fitting portion fitted to the inner diameter portion in the first region.

### BACKGROUND

### Technical Field

The present disclosure relates to a lens mount, a camera mount, an optical apparatus, an imaging apparatus, and an imaging system.

### Description of the Related Art

A lens mount for attaching an optical apparatus such as a lens apparatus, an adapter, or an extender to an interchangeable lens camera is provided at an image side end of the optical apparatus, and the center of gravity of the optical apparatus is located on the object side with respect to the lens mount. Therefore, a moment is generated around the lens mount. This moment increases as the distance from the lens mount to the center of gravity of the optical apparatus increases and the mass of the lens apparatus increases.

Japanese Patent Application Laid-Open No. 2021-128203 discloses a lens apparatus having a configuration in which a camera portion and a lens mount are connected and fixed to each other by a bayonet structure.

### SUMMARY

According to an embodiment of the present disclosure, there is provided a lens mount attachable to and detachable from a camera mount, the lens mount comprising: an outer diameter portion fitted to an inner diameter portion of the camera mount, wherein the outer diameter portion includes a first region and a second region located closer to an object side than the first region.

Further features of the disclosure will become apparent from the following description of exemplary embodiments with reference to the attached drawings.

### BRIEF DESCRIPTION OF THE DRAWINGS

FIG. 1 illustrates a representative configuration of an imaging system of the present disclosure.

FIG. 2 illustrates a representative configuration of the imaging system of the present disclosure.

FIG. 3A, FIG. 3B, FIG. 3C and FIG. 3D are diagrams illustrating a lens mount (110) according to embodiment 1.

FIG. 4 is a perspective view illustrating the camera mount 210 according to embodiment 1.

FIG. 5 is a perspective view illustrating a state before the lens mount (110) is inserted into the camera mount (210).

FIG. 6 is a side view illustrating a state in which insertion of the lens mount (110) into the camera mount (210) is started.

FIG. 7 is a side view illustrating a state in which the lens mount (110) is being inserted into the camera mount (210).

FIG. 8 is a perspective view illustrating a state in which the flange surface (111) and the mount surface (211) are in contact with each other.

FIG. 9 is a perspective view illustrating a state in which the attachment of the lens apparatus (100) to the camera (200) is completed.

FIG. 10A, FIG. 10B, FIG. 10C and FIG. 10D are diagrams illustrating a lens mount (110) according to a modification 1 of the embodiment 1.

FIG. 11A, FIG. 11B, FIG. 11C and FIG. 11D are diagrams illustrating a lens mount (110) according to a modification 2 of the embodiment 1.

FIG. 12A, FIG. 12B, FIG. 12C and FIG. 12D are diagrams illustrating a lens mount (120) according to embodiment 2.

FIG. 13 is a view illustrating a camera mount (220) according to the second embodiment.

### DESCRIPTION OF THE EMBODIMENTS

Preferred embodiments of the present invention will now be described in detail in accordance with the accompanying drawings.

### Embodiment 1

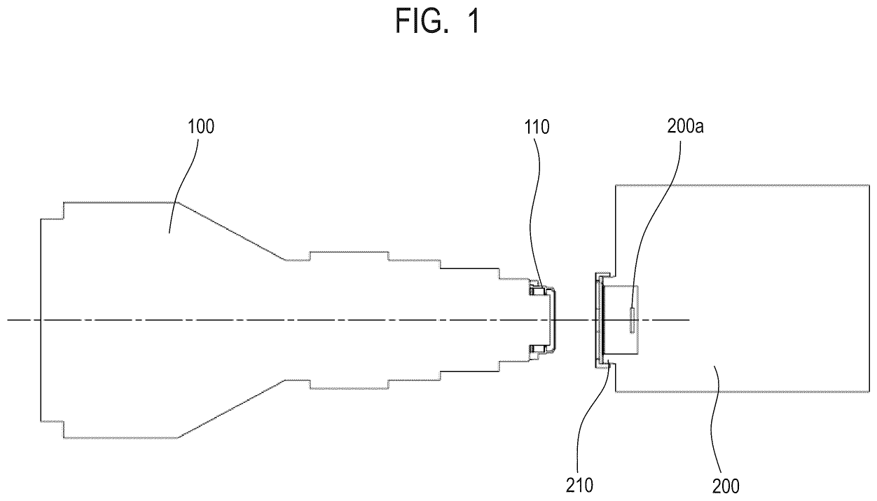

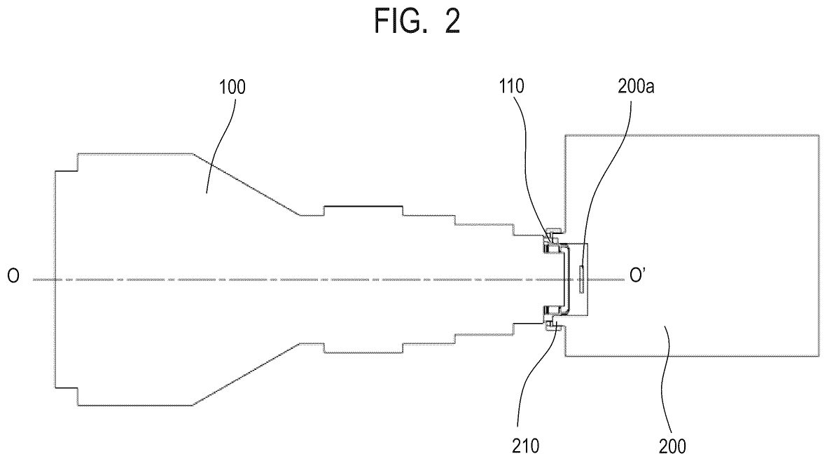

A typical configuration of a lens apparatus 100 (optical apparatus) according to an embodiment 1 is illustrated in FIG. 1 to FIG. 11D. FIG. 1 and FIG. 2 illustrate a representative configuration of an imaging system using the lens apparatus 100 and a camera 200 (imaging apparatus) of the present disclosure. The lens apparatus 100 is provided with a lens mount 110 for detachably attaching the lens apparatus 100 to a camera mount 210 and a lens (not illustrated), and the camera 200 is provided with the camera mount 210 and an image sensor 200a. The imaging system of the present disclosure includes the lens apparatus 100 and the camera 200 including the image sensor 200a for capturing an image formed by the lens apparatus 100. FIG. 1 illustrated a state before the lens mount 110 is fixed to the camera mount 210. FIG. 2 illustrates a state in which the lens mount 110 at a normal position is fixed to the camera mount 210 by a bayonet structure, and a light beam enters the image sensor 200a along the optical axis O-O′ from the object side toward the image side.

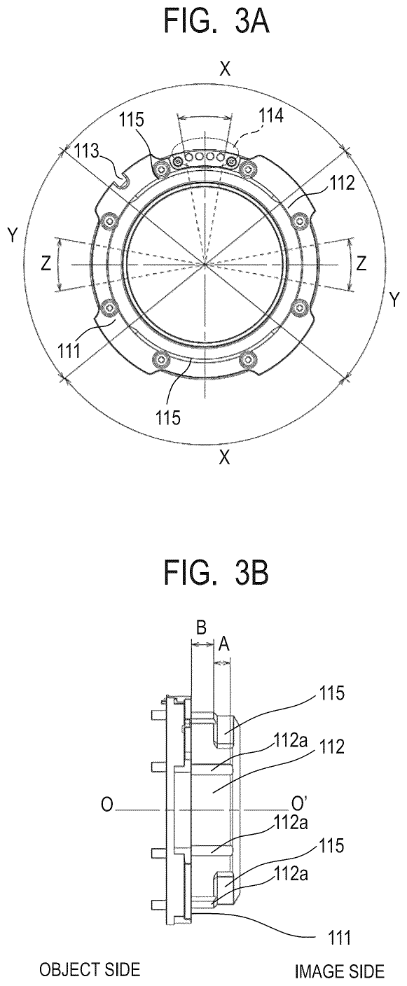

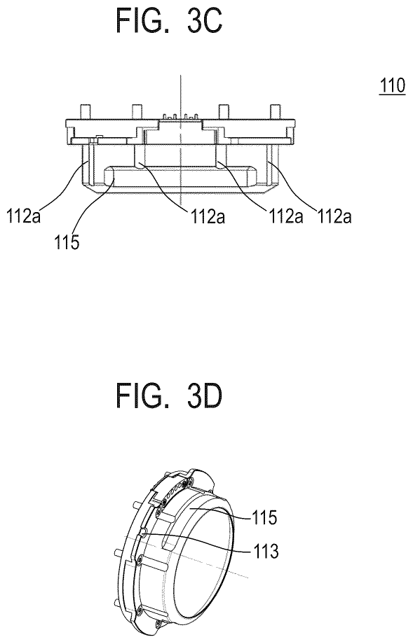

FIGS. 3A to 3D are diagrams illustrating a lens mount structure of a lens mount 110 according to embodiment 1 of the present disclosure, and FIG. 3A is a front view, FIG. 3B is a side view, FIG. 3C is a plan view, FIG. 3D is a perspective view. As illustrated in FIG. 3B, the lens mount 110 is provided with a flange surface 111 that extends in a radial direction perpendicular to the optical axis O-O′, and a lens mount outer diameter portion 112 that is parallel to the optical axis O-O′ and fits into a camera mount inner diameter portion 212 (described later) of the camera mount 210. As illustrated in FIG. 3A, the flange surface 111 of the lens mount 110 is provided with a lens side positioning groove 113 (concave portion) for positioning and lens contacts 114 (electrical contacts). In this embodiment, the lens contacts 114 is disposed with its center on the vertically upper side with respect to the optical axis O-O′.

At least one cutout portion 115 is provided in the lens mount outer diameter portion 112 along the circumferential direction of the lens mount outer diameter portion 112. And the lens mount outer diameter portion 112 includes a first region and a second region located closer to the object side than the first region. The cutout portion 115 is provided along the circumferential direction in the first region, but the cutout portion 115 is not provided in the second region. The cutout portion 115 is formed in the lens mount outer diameter portion 112 so as to have a predetermined length A in the optical axis direction and a non-fitting circumferential length X within a predetermined angle range along the circumferential direction so as to not engage with the camera mount inner diameter portion 212. And the first region is an annular region on the image side of the lens mount outer diameter portion 112 that has a width of length A in the optical axis direction. And the second region is an annular region on the object side of the lens mount outer diameter portion 112 that has a predetermined length B in the optical axis direction. And the circumferential length of the second region fitted to the camera mount inner diameter portion 212 is the total circumferential length of the lens mount outer diameter portion 112 minus the circumferential length of a plurality of screw grooves 112a provided for screw fastening. On the other hand, the circumferential length of the first region fitted to the camera mount inner diameter portion 212 is a fitting circumferential length Y as illustrated in FIG. 3A. Then, the total circumferential length of the fitting portion (first fitting portion) fitted to the camera mount inner diameter portion 212 in the second region is longer than the circumferential length (fitting circumferential length Y) of the fitting portion (second fitting portion) fitted to the camera mount inner diameter portion 212 in the first region. A distance from the center of the lens mount 110 to the fitting portion (first fitting portion) is longer than a distance from the center to the cutout portion 115. Further, in the state where the lens mount 110 is mounted on the camera mount 210, the flange surface 111 is located closer to the object side than the second region.

The cutout portion 115 of the present embodiment is provided on a vertical line passing through the center of the first region in a state in which the lens mount 110 is mounted on the camera mount 210 at the normal position. That is, it is provided on either the upper side or the lower side, or both the upper side and the lower side, centered on the vertical direction. When the cutout portion 115 is provided on both the upper side and lower side, the circumferential length (2Y) of the first region fitted to the camera mount inner diameter portion 212 is twice the fitting circumferential length Y. The cutout portions 115 each have a non-fitting circumferential length X in a range of a predetermined angle along the circumferential direction and are provided in a range of a predetermined length A in the optical axis direction, that is, within the range of the length A from the distal end portion on the image side of the fitting portion of the lens mount outer diameter portion 112. At this time, the distance (length A+length B) in the optical axis direction from the flange surface 111 of the lens mount 110 to the end portion on the image side of the fitting portion (first fitting portion) of the lens mount outer diameter portion 112 is equal to or less than 12 mm.

And in the present embodiment, the cutout portion 115 has a shape that widens with respect to the vertical direction. Further, the cutout portion 115 is provided in a direction in which a moment due to the center of gravity of the lens apparatus 100 is generated. With this configuration, when the lens mount outer diameter portion 112 is inserted into the camera mount inner diameter portion 212, the regulation of the inclination due to the fitting in the direction in which the inclination is likely to occur is relaxed, and it is possible to improve the attachment workability of the lens apparatus 100 to the camera 200. Furthermore, in the present embodiment, in a range of an angle Z of a phase of ±90 degree in the circumferential direction with respect to the lens contacts 114 provided on the lens mount 110, the cutout portion 115 is not provided in the first region of the lens mount outer diameter portion 112. With this configuration, inclination around the vertical axis is regulated, and the lens contacts 114 and camera contacts 214 (to be described later) can be accurately brought into contact with each other when the lens apparatus 100 is attached to the camera 200.

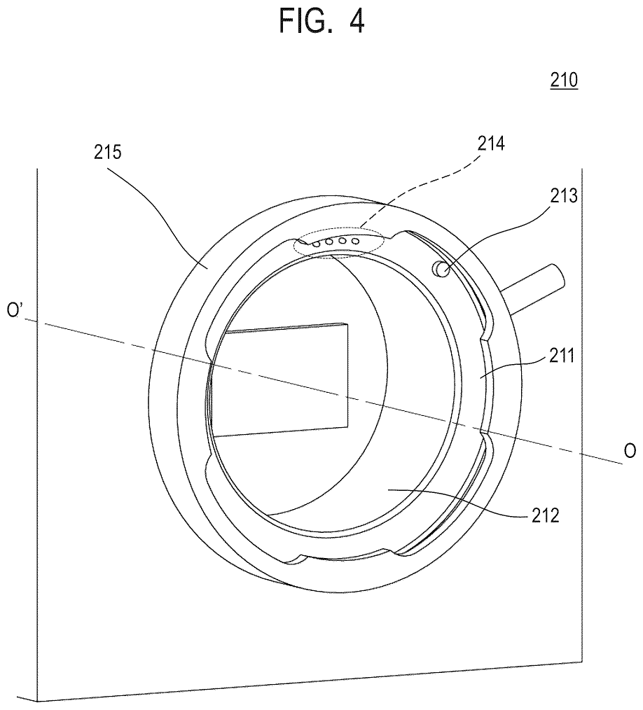

FIG. 4 is a perspective view illustrating the camera mount 210 which is attachable to and detachable from a lens mount 110 according to embodiment 1 of the present disclosure. The camera mount 210 being provided with a mount surface 211 perpendicular to an optical axis O-O′ and the camera mount inner diameter portion 212 parallel to the optical axis O-O′. The mount surface 211 of the camera mount 210 is provided with a camera side positioning pin 213 (convex portion) corresponding to the lens side positioning groove 113 and the camera contacts 214. Note that the length of the camera side positioning pin 213 along the optical axis direction is shorter than the length B of the second region in the optical axis direction. In this embodiment, the camera contacts 214 is disposed with its center on the vertically upper side with respect to the optical axis O-O′. A mount ring 215 is screwed to the camera mount 210 and can be rotated to switch between a fixed position and an open position.

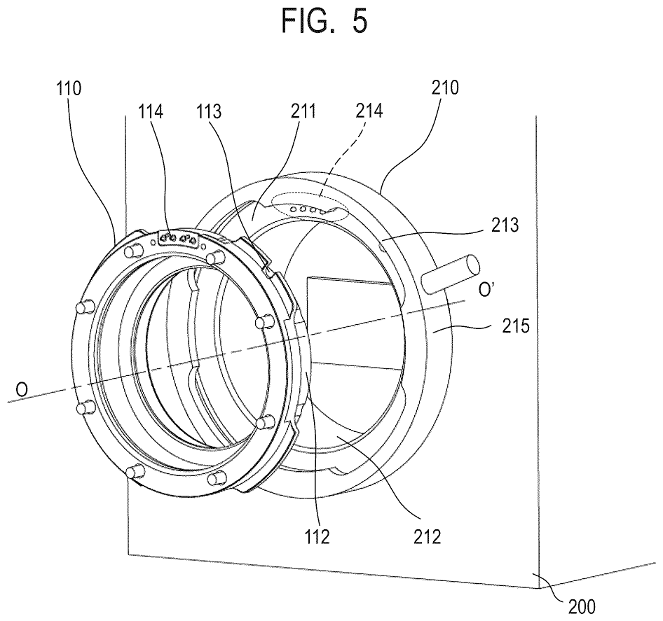

FIG. 5 to FIG. 9 illustrate a mechanism of a mount structure when the lens apparatus 100 is attached to the camera 200. FIG. 5 is a perspective view illustrating a state before the lens mount 110 is inserted into the camera mount 210, and the lens apparatus 100 is not illustrated. In a bayonet structure for attaching the lens apparatus 100 to the camera 200, the lens mount outer diameter portion 112 is inserted toward the camera mount inner diameter portion 212, and phases in the circumferential direction of the camera side positioning pin 213 and the lens side positioning groove 113 are visually matched.

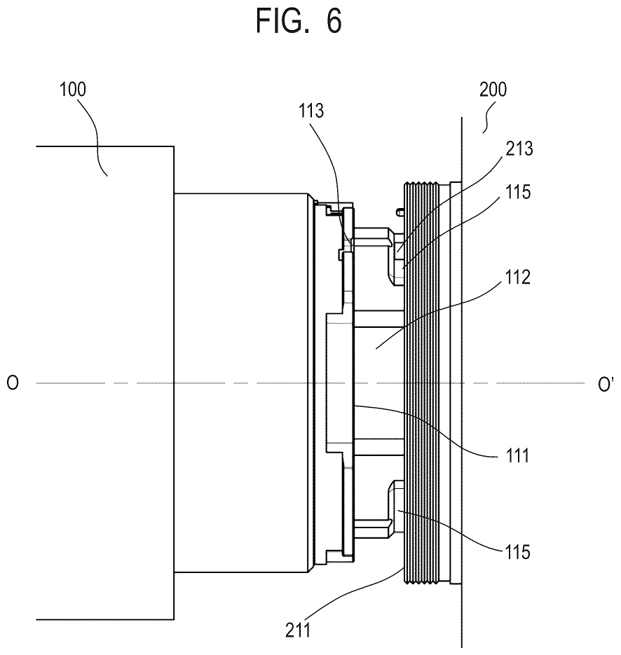

FIG. 6 is a side view illustrating a state in which insertion of the lens mount 110 into the camera mount 210 has started, and the mount ring 215 is not illustrated. The lens mount outer diameter portion 112 is fitted into the camera mount inner diameter portion 212 (not illustrated), but there are gaps between the lens mount outer diameter portion 112 and the camera mount inner diameter portion 212 in the range of the upper and lower cutout portions 115.

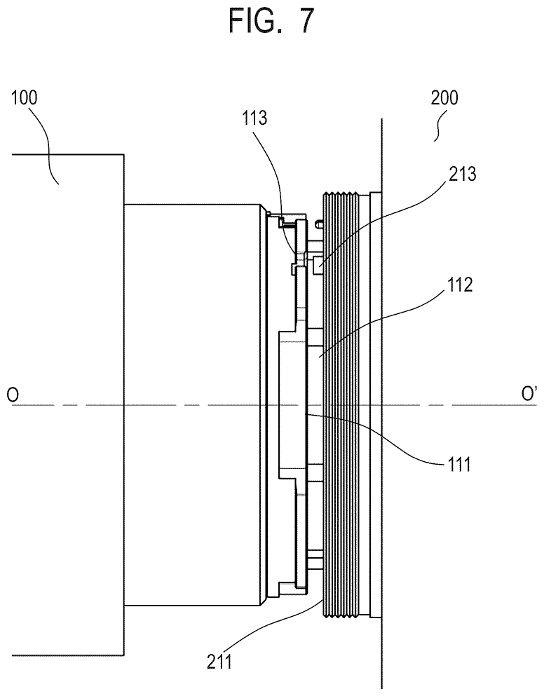

FIG. 7 is a side view illustrating a state during insertion in which the insertion of the lens mount 110 has been further advanced, and the lens mount 110, the camera mount 210, and the mount ring 215 are not illustrated. The lens mount 110 is fitted to the camera mount 210 in a range where the cutout portion 115 of the lens mount outer diameter portion 112 does not exist. At this time, the camera side positioning pin 213 is not yet in contact with the lens side positioning groove 113.

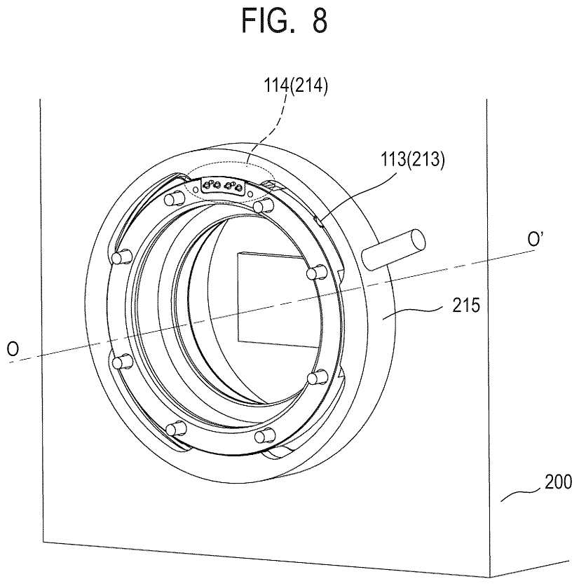

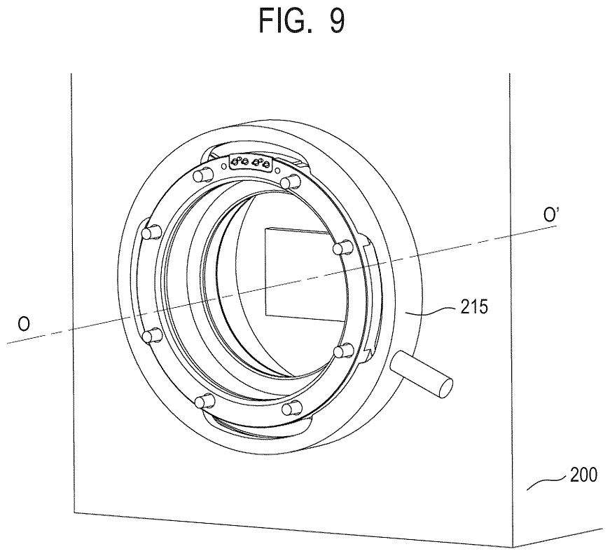

FIG. 8 is a perspective view illustrating a state in which the flange surface 111 and the mount surface 211 are in contact with each other, and the lens apparatus 100 is not illustrated. The camera side positioning pin 213 is fitted into the lens side positioning groove 113, and the lens contacts 114 are in contact with the camera contacts 214. FIG. 9 is a perspective view illustrating a state in which the attachment of the lens apparatus 100 to the camera 200 is completed. In a state where the flange surface 111 of the lens mount 110 is abutted against the mount surface 211 by rotating the mount ring 215 to a fixing position, the lens apparatus 100 is fixed to the camera 200.

As described above, in the lens mount 110 of this embodiment, the cutout portion 115 extending in a part of the circumferential direction is provided on the image side of the lens mount outer diameter portion 112 of the lens mount 110, so that the fitting circumferential length Y until the middle of the insertion of the lens mount 110 is short. With such a configuration, it is possible to allow the inclination of the lens apparatus 100 with respect to the camera 200, and it is possible to reduce the rubbing between the fitting surfaces. In addition, before the camera side positioning pin 213 is fitted into the lens side positioning groove 113, the length of the lens mount outer diameter portion 112 in the circumferential direction which is fitted into the camera mount inner diameter portion 212 is increased. With this configuration, by regulating the inclination of the lens apparatus 100 with respect to the camera 200 and it is possible to easily find the position of the camera side positioning pin 213. According to the present disclosure, it is possible to provide the lens mount 110 that improves the workability of attaching the lens apparatus 100 to the camera 200.

### (Modification 1)

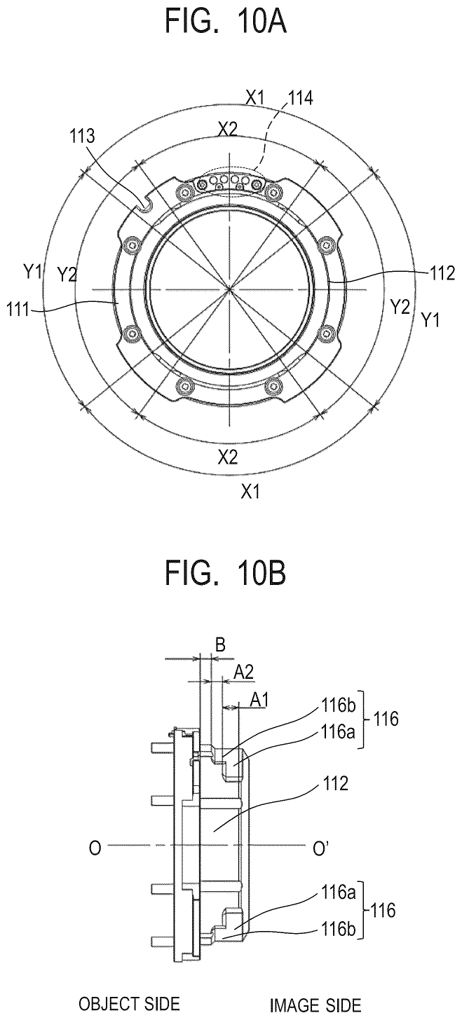

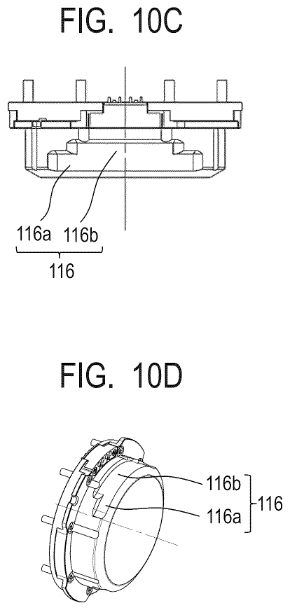

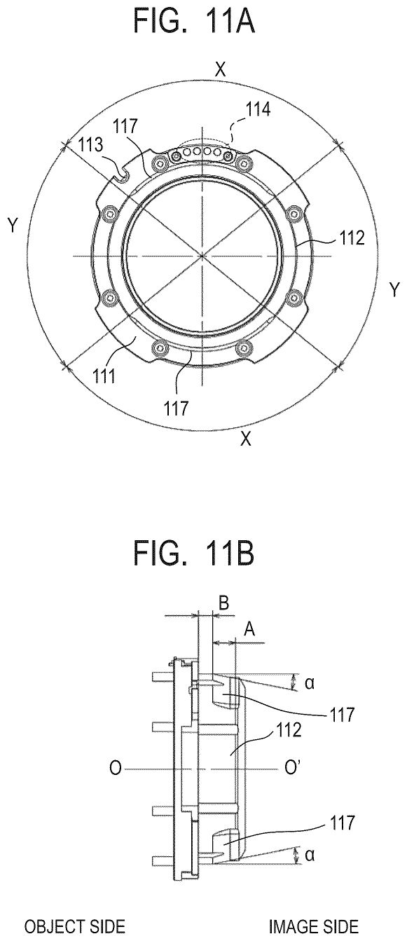

FIGS. 10A to 10D are a diagram illustrating a lens mount structure of a lens mount 110 according to a modification 1 of the embodiment 1 of the present disclosure, and a diagram FIG. 10A is a front view, FIG. 10B is a side view, FIG. 10C is a plan view, and FIG. 10D is a perspective view. The shape of a cutout portion 116 of the modification 1 is divided into shapes having multiple fitting circumferential lengths, as illustrated in FIG. 10B. The cutout portion 116 includes a large cutout portion 116a (first cutout portion) that forms a short fitting circumferential length Y1, and a small cutout portion 116b (second cutout portion) that forms a long fitting circumferential length Y2. At least one cutout portion 116 is provided in the lens mount outer diameter portion 112 along the circumferential direction of the lens mount outer diameter portion 112. And the lens mount outer diameter portion 112 includes a first region and a second region located closer to the object side than the first region. The cutout portion 116 is provided along the circumferential direction in the first region, but the cutout portion 116 is not provided in the second region. The large cutout portion 116a is formed in the lens mount outer diameter portion 112 so as to have a predetermined length A1 in the optical axis direction and a non-fitting circumference length X1 within a predetermined angle range along the circumferential direction so as to not engage with the camera mount inner diameter portion 212. The small cutout portion 116b is formed in the lens mount outer diameter portion 112 so as to have a predetermined length A2 in the optical axis direction and a non-fitting circumferential length X2 within a predetermined angle along the circumferential direction so as to not engage with the camera mount inner diameter portion 212. And the first region is an annular region on the image side of the lens mount outer diameter portion 112 that has a width of the length A1+length A2 in the optical axis direction. And the second region is an annular region on the object side of the lens mount outer diameter portion 112 that has a predetermined length B in the optical axis direction. That is, the first region is formed with a plurality of portions having different lengths in the circumferential direction, such as the large cutout portion 116a and the small cutout portion 116b. At the start of insertion of the lens apparatus 100, the fitting circumferential length Y1 becomes shorter due to the large cutout portion 116a, and as the insertion progresses, the fitting circumferential length Y2 becomes longer due to the small cutout portion 116b, and as the insertion further progresses, the range without the cutout portion 116 is reached, and it is possible to increase the fitting circumferential length in a stepwise manner. With this configuration, it is possible to reduce a change in the fitting circumferential length due to the insertion depth, and thus it is possible to smoothly insert the lens mount 110.

### (Modification 2)

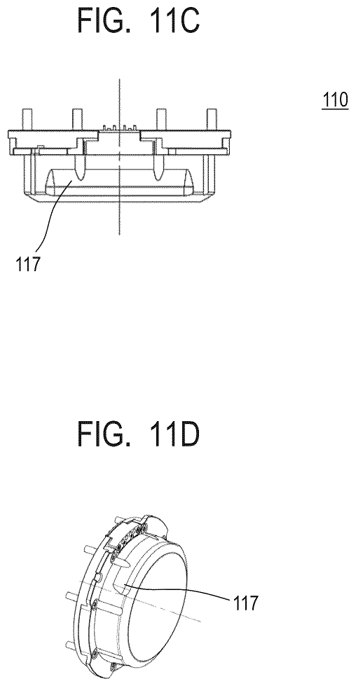

FIGS. 11A to 11D are a diagram illustrating a lens mount structure of a lens mount 110 according to a modification 2 of the embodiment 1 of the present disclosure, in which FIG. 11A is a front view, FIG. 11B is a side view, FIG. 11C is a plan view, and FIG. 11D is a perspective view. A shape of a cutout portion 117 of the modification 2 is a tapered shape inclined with respect to the optical axis O-O′. More specifically, the shape is a tapered shape in which the length in the radial direction of the lens mount 110 is gradually increased toward the object side at an angle α with respect to the optical axis O-O′. That is, a surface extending along the circumferential direction of the cutout portion 117 is inclined at the angle α with respect to the optical axis O-O′. According to this configuration, since the fitting circumferential length Y can be continuously changed along the optical axis direction, the lens mount 110 can be more smoothly inserted.

### Embodiment 2

A typical structure of the lens apparatus 100 according to the embodiment 2 will be described. The mechanism of the mount structure when the lens apparatus 100 is attached to the camera 200 is the same as that in embodiment 1, and therefore the drawing thereof is omitted.

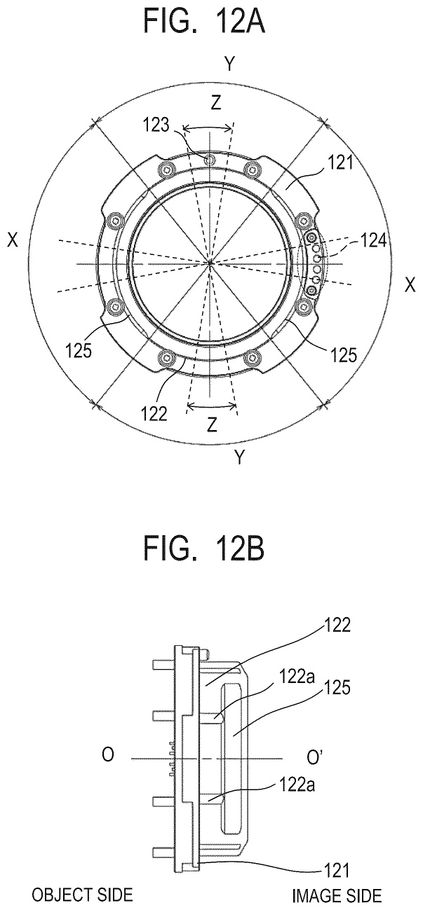

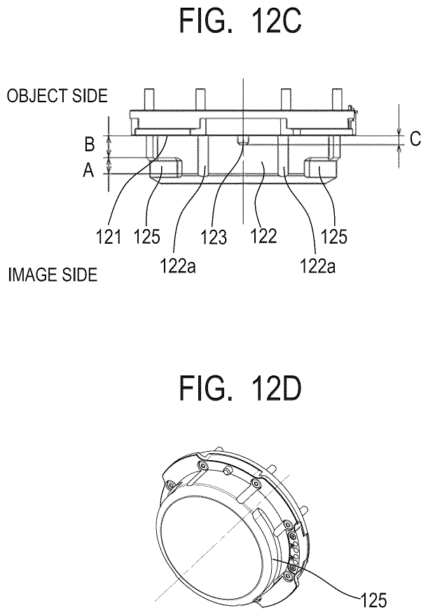

FIGS. 12A to 12D are diagrams illustrating a lens mount structure of a lens mount 120 according to the embodiment 2 of the present disclosure, in which FIG. 12A is a front view, FIG. 12B is a side view, FIG. 12C is a plan view, and FIG. 12D is a perspective view. As illustrated in FIG. 12B, the lens mount 120 is provided with a flange surface 121 perpendicular to the optical axis O-O′ and a lens mount outer diameter portion 122 parallel to the optical axis O-O′. As illustrated in FIG. 12A, a lens side positioning pin 123 (convex portion) and lens contacts 124 (electrical contacts) for positioning are provided on the flange surface 121 of the lens mount 120. In this embodiment, the lens contacts 124 is disposed at the center on the right side in the horizontal direction with respect to the optical axis O-O′.

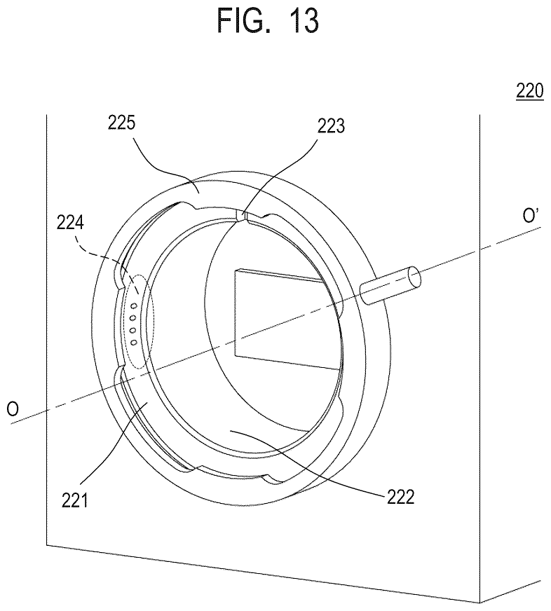

At least one cutout portion 125 is provided in the lens mount outer diameter portion 122 along the circumferential direction of the lens mount outer diameter portion 122. And the lens mount outer diameter portion 122 includes a first region and a second region located closer to the object side than the first region. The cutout portion 125 is provided along the circumferential direction in the first region, but the cutout portion 125 is not provided in the second region. The cutout portion 125 is formed in the lens mount outer diameter portion 122 so as to have a predetermined length A in the optical axis direction and a non-fitting circumferential length X within a predetermined angle range along the circumferential direction so as to not engage with a camera mount inner diameter portion 222 (see FIG. 13). And the first region is an annular region on the image side of the lens mount outer diameter portion 122 that has a width of the length A in the optical axis direction. And the second region is an annular region on the object side of the lens mount outer diameter portion 122 that has a predetermined length B in the optical axis direction. And the circumferential length of the second region fitted to the camera mount inner diameter portion 222 is the total circumferential length of the lens mount outer diameter portion 122 minus the circumferential length of a plurality of screw grooves 122a provided for screw fastening. On the other hand, the circumferential length of the first region fitted to the camera mount inner diameter portion 222 is a fitting circumferential length Y as illustrated in FIG. 12A. Then, the total circumference length of the fitting portion (first fitting portion) fitted to the camera mount inner diameter portion 222 in the second region is longer than the circumferential length (fitting circumferential length Y) of the fitting portion (second fitting portion) fitted to the camera mount inner diameter portion 222 in the first region.

The cutout portion 125 of the present embodiment is provided on a horizontal line passing through the center of the first region in a state in which the lens mount 120 is mounted on the camera mount 210 at the normal position. That is, it is provided on both the right side and the left side, centered on the horizontal direction. When the cutout portions 125 are provided on both the left side and the right side, the circumferential lengths (2Y) of the first region fitted to the camera mount inner diameter portion 222 are twice the fitting circumferential lengths Y. The cutout portions 125 each have a non-fitting circumferential length X in a range of a predetermined angle along the circumferential direction and are provided in a range of a predetermined length A in the optical axis direction, that is, within the range of the length A from the distal end portion on the image side of the fitting portion of the lens mount outer diameter portion 122. At this time, the distance (length A+length B) in the optical axis direction from the flange surface 121 of the lens mount 120 to the end portion on the image side of the fitting portion (first fitting portion) of the lens mount outer diameter portion 122 is equal to or less than 12 mm.

And in the present embodiment, the cutout portion 125 has a shape that widens with respect to the horizontal direction. Furthermore, in a range of an angle Z of a phase of ±90 degree in the circumferential direction with respect to the lens contacts 124 provided on the lens mount 120, the cutout portion 125 is not provided in the first region of the lens mount outer diameter portion 122. With this configuration, inclination around the horizontal axis is regulated, and the lens contacts 124 and camera contacts 224 can be accurately brought into contact with each other when the lens apparatus 100 is attached to the camera 200.

FIG. 13 is a perspective view illustrating a camera mount 220 according to the embodiment 2 of the present disclosure. The camera mount 220 is provided with a mount surface 221 perpendicular to the optical axis O-O′ and the camera mount inner diameter portion 222 parallel to the optical axis O-O′. The mount surface 221 of the camera mount 220 is provided with a camera side positioning groove 223 (concave portion) corresponding to the lens side positioning pin 123 and camera contacts 224. In the present embodiment, the camera contacts 224 is disposed at the center on the left side in the horizontal direction with respect to the optical axis O-O′. A mount ring 225 is screwed to the camera mount 220 and can be switched between a fixed position and an open position by being rotated.

When the lens apparatus 100 is attached to the camera 200, the lens mount outer diameter portion 122 is inserted toward the camera mount inner diameter portion 222, and the phases of the lens side positioning pin 123 and the camera side positioning groove 223 are visually aligned. When the insertion is started, the lens mount outer diameter portion 122 is fitted into the camera mount inner diameter portion 222, but there is a clearance between the lens mount outer diameter portion 122 and the camera mount inner diameter portion 222 in the range of the left cutout portion 125 and right cutout portion 125. When the insertion is further advanced, the lens mount outer diameter portion 122 is fitted to the camera mount inner diameter portion 222 in a range where the cutout portion 125 of the lens mount outer diameter portion 122 does not exist. The lens side positioning pin 123 is fitted into the camera side positioning groove 223 after the fitting is started in a range where the cutout portion 125 is not provided. When the flange surface 121 and the mount surface 221 come into contact with each other, the lens contacts 124 and the camera contacts 224 come into contact with each other. Finally, the mount ring 225 is rotated to the fixed position to complete the attachment of the lens apparatus 100 to the camera 200. A length C of the lens side positioning pin 123 along the optical axis direction is shorter than the length B of the second region in the optical axis direction. In addition, an example in which the lens side positioning pin 123 is provided in the lens mount 120 has been described, but a convex portion may be provided in one of the camera mount 210 and the lens mount 120, and a concave portion into which the convex portion is fitted may be provided in the other.

As described above, in the lens mount 120 of this embodiment, the by providing the cutout portion 125 extending in a part of the circumferential direction is provided on the image side of the lens mount outer diameter portion 122 of the lens mount 120, so that the fitting circumferential length Y until the middle of the insertion of the lens mount 120 is short. With such a configuration, it is possible to allow the inclination of the lens apparatus 100 with respect to the camera 200, and it is possible to reduce the rubbing between the fitting surfaces. In addition, before the lens side positioning pin 123 is fitted into the camera side positioning groove 223, the length of the lens mount outer diameter portion 122 in the circumferential direction which is fitted into the camera mount inner diameter portion 222 is increased. With this configuration, by regulating the inclination of the lens apparatus 100 with respect to the camera 200 and it is possible to easily find the position of the lens side positioning pin 123. According to the present disclosure, it is possible to provide the lens mount 120 that improves the workability of attaching the lens apparatus 100 to the camera 200.

Although the preferred embodiments of the present disclosure have been described above, the present disclosure is not limited to these embodiments, and various modifications and changes can be made within the scope of the gist of the present disclosure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-204338, filed Dec. 4, 2023, which is hereby incorporated by reference herein in its entirety.

What is claimed is:

1. A lens mount attachable to and detachable from a camera mount, the lens mount comprising:
an outer diameter portion fitted to an inner diameter portion of the camera mount,
wherein the outer diameter portion includes a first region and a second region located closer to an object side than the first region, and
wherein a length in a circumferential direction of a first fitting portion fitted to the inner diameter portion in the second region is longer than a length in the circumferential direction of a second fitting portion fitted to the inner diameter portion in the first region.

2. The lens mount according to claim 1, wherein a cutout portion is provided in the first region along the circumferential direction, and a distance from a center of the lens mount to the first fitting portion is longer than a distance from the center to the cutout portion.

3. The lens mount according to claim 2, wherein the cutout portion is not provided in the second region.

4. The lens mount according to claim 2, wherein the cutout portion is provided on a vertical line passing through the center of the first region in a state in which the lens mount is mounted on the camera mount at a normal position.

5. The lens mount according to claim 2, wherein the cutout portion is provided on a horizontal line passing through the center of the first region in a state in which the lens mount is mounted on the camera mount at a normal position.

6. The lens mount according to claim 2, wherein the lens mount is provided with an electrical contact, and the cutout portion is not provided in the first region in a range of ±90 degree in the circumferential direction with respect to the electrical contact.

7. The lens mount according to claim 1,
wherein one of the camera mount and the lens mount is provided with a convex portion, and the other is provided with a concave portion into which the convex portion is fitted,
wherein a length of the convex portion is shorter than a length of the second region in an optical axis direction.

8. The lens mount according to claim 1, wherein the lens mount has a flange surface extending in a radial direction, and the flange surface is located closer to the object side than the second region.

9. The lens mount according to claim 8, wherein a distance in an optical axis direction from the flange surface to an end portion on an image side of the first fitting portion is equal to or less than 12 mm.

10. The lens mount according to claim 1, wherein the first region is provided with a plurality of cutout portions having different lengths in the circumferential direction.

11. The lens mount according to claim 2, wherein a surface extending in the circumferential direction of the cutout portion is inclined with respect to an optical axis.

12. An optical apparatus comprising a lens mount and a lens,
the lens mount attachable to and detachable from a camera mount, the lens mount comprising:
an outer diameter portion fitted to an inner diameter portion of the camera mount,
wherein the outer diameter portion includes a first region and a second region located closer to an object side than the first region, and
wherein a length in a circumferential direction of a first fitting portion fitted to the inner diameter portion in the second region is longer than a length in the circumferential direction of a second fitting portion fitted to the inner diameter portion in the first region.

13. An imaging system including an optical apparatus and an imaging element,
the optical apparatus comprising a lens mount and a lens, the lens mount attachable to and detachable from a camera mount, the lens mount comprising:
an outer diameter portion fitted to an inner diameter portion of the camera mount,
wherein the outer diameter portion includes a first region and a second region located closer to an object side than the first region, and
wherein a length in a circumferential direction of a first fitting portion fitted to the inner diameter portion in the second region is longer than a length in the circumferential direction of a second fitting portion fitted to the inner diameter portion in the first region.

14. A camera mount attachable to and detachable from a lens mount, the lens mount comprising:
an outer diameter portion fitted to an inner diameter portion of the camera mount,
wherein the outer diameter portion includes a first region and a second region located closer to an object side than the first region, and
wherein a length in a circumferential direction of a first fitting portion fitted to the inner diameter portion in the second region is longer than a length in the circumferential direction of a second fitting portion fitted to the inner diameter portion in the first region,
wherein the camera mount includes the inner diameter portion.
